(19) United States
(12) Patent Application Publication
(10) Pub. No.: US 2018/0346709 A1
(43) Pub. Date: Dec. 6, 2018

(54) THERMOPLASTIC RESIN COMPOSITION

(71) Applicant: NIPPON A&L INC., Osaka-shi, Osaka (JP)

(72) Inventors: Masaki MURATA, Takaishi-shi, Osaka (JP); Masaaki OKADA, Takaishi-shi, Osaka (JP)

(21) Appl. No.: 15/777,881

(22) PCT Filed: Dec. 1, 2016
(86) PCT No.: PCT/JP2016/085781

§ 371 Date: May 21, 2018

(30) Foreign Application Priority Data
Dec. 8, 2015 (JP) 2015-239644

(51) Int. Cl. C08L 55/02; C08L 69/00

(52) U.S. Cl. CPC C08L 55/02; C08L 2201/08; C08L 69/00

(57) ABSTRACT

The present invention provides a thermoplastic resin composition, comprising: a thermoplastic resin consisting of 30 to 90 mass % of a polycarbonate resin and 10 to 70 mass % of a styrene-based resin; an ultraviolet absorber; and an N—R type hindered amine light stabilizer, wherein the content of the ultraviolet absorber is 0.01 to 3 parts by mass, and the content of the N—R type hindered amine light stabilizer is 0.01 to 3 parts by mass with respect to 100 parts by mass of the thermoplastic resin.

### TECHNICAL FIELD

The present invention relates to a thermoplastic resin composition.

### BACKGROUND ART

Thermoplastic resin compositions comprising polycarbonate resin and styrene-based resin are widely used in many fields due to being excellent in shock resistance, moldability, heat resistance and the like. Materials having high light resistance in addition to the above excellent performance that the thermoplastic resin compositions have are required to satisfy a demand for appearance and safety particularly in fields such as an electrical field, an electronic field, and an OA field. Materials that are excellent in not only light resistance but also fire retardancy may be required.

The thermoplastic resin compositions generally have a problem of being tinged with yellow (yellowing) in the case of being exposed to light including ultraviolet rays excessively. For this reason, there are problems that when molded products consisting of the thermoplastic resin compositions are exposed to light including ultraviolet rays for a long period of time, yellowing occurs, resulting in markedly spoiling the appearance of the molded products, and further the resins are decomposed by ultraviolet rays, resulting in markedly decreasing the strength of the molded products.

To solve the above problems, it has been considered blending a benzotriazole ultraviolet absorber or a hindered amine light stabilizer, and it is generally known the hindered amine light stabilizer has a much higher effect of detering yellowing that occurs when ultraviolet rays are irradiated than the benzotriazole ultraviolet absorber particularly in the thermoplastic resin compositions.

However, the hindered amine light stabilizer generally has a fundamental problem of causing an extreme decrease in molecular weight due to not only thermal decomposition of the polycarbonate resin but also its hydrolysis at high temperature and humidity in pelletizing or molding. For example, in the following Patent Literature 1, inclusion of a hindered amine light stabilizer having a particular structure and a polyether polymer is also considered, but the consideration is not enough yet.

### CITATION LIST

### Patent Literature

Patent Literature 1: Japanese Unexamined Patent Publication No. 11-217495

### SUMMARY OF INVENTION

### Technical Problem

An object of the present invention is to provide a thermoplastic resin composition that contains a thermoplastic resin consisting of a polycarbonate resin and a styrene-based resin and is excellent in light resistance and moist heat resistance.

### Solution to Problem

The present invention provides a thermoplastic resin composition comprising: a thermoplastic resin consisting of 30 to 90 mass % of a polycarbonate resin and 10 to 70 mass % of a styrene-based resin; an ultraviolet absorber; and an N—R type hindered amine light stabilizer, wherein the content of the ultraviolet absorber is 0.01 to 3 parts by mass, and the content of the N—R type hindered amine light stabilizer is 0.01 to 3 parts by mass with respect to 100 parts by mass of the thermoplastic resin.

It is preferable that the N—R type hindered amine light stabilizer in the thermoplastic resin composition is a polycondensate of dimethyl succinate and 4-hydroxy-2,2,6,6-tetramethyl-1-piperidine ethanol.

It is preferable that the thermoplastic resin composition further comprises a N—CH₃ type hindered amine light stabilizer, and the content of the N—CH₃ type hindered amine light stabilizer is 0.01 to 1 part by mass with respect to 100 parts by mass of the thermoplastic resin.

### Advantageous Effects of Invention

According to the present invention, a thermoplastic resin composition that contains a thermoplastic resin consisting of a polycarbonate resin and a styrene-based resin and is excellent in light resistance and moist heat resistance can be provided.

### DESCRIPTION OF EMBODIMENTS

The thermoplastic resin composition according to one embodiment of the present invention contains a thermoplastic resin, an ultraviolet absorber and a N—R type hindered amine light stabilizer. The thermoplastic resin composition of the present embodiment may further contain an N—CH₃ type hindered amine light stabilizer. The components constituting the thermoplastic resin composition of the present embodiment will be described hereinafter.

The thermoplastic resin used in the thermoplastic resin composition of the present embodiment consists of 30 to 90 mass % of a polycarbonate resin and 10 to 70 mass % a styrene-based resin. In the case of less than 30 mass % of the polycarbonate resin, light resistance, moist heat resistance and shock resistance are inferior, and in the case of more than 90 mass %, moldability is inferior. In view of improving light resistance, moist heat resistance, shock resistance and moldability in better balance, it is preferable that the thermoplastic resin consist of 40 to 80 mass % of the polycarbonate resin and 20 to 60 mass % of the styrene-based resin, and it is more preferable that the thermoplastic resin consist of 50 to 70 mass % of the polycarbonate resin and 30 to 50 mass % of the styrene-based resin. When other thermoplastic resin components than the polycarbonate resin and the styrene-based resin are contained, light resistance and moist heat resistance may be inferior, and therefore the thermoplastic resin of the present embodiment consists of only the polycarbonate resin and the styrene-based resin. It is preferable that the thermoplastic resin composition of the present embodiment contain only the polycarbonate resin and the styrene-based resin (namely, does not contain other resin components than the polycarbonate resin and the styrene-based resin) in view of suppressing decreases in light resistance and moist heat resistance.

The polycarbonate resin is a polymer obtained by the phosgene method in which any of various dihydroxydiaryl compounds and phosgene are reacted or by the transesterification method in which a dihydroxydiaryl compound and a carbonate ester such as diphenyl carbonate are reacted, and representative examples thereof include 2,2-bis(4-hydroxyphenyl)propane; and a polycarbonate resin produced from “bisphenol A”.

Examples of the dihydroxydiaryl compounds include bis(hydroxyaryl)alkanes such as bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, 2,2-bis(4-hydroxyphenyl-3-methylphenyl)propane, 1,1-bis(4-hydroxy-3-t-butylphenyl)propane, 2,2-bis(4-hydroxy-3-bromophenyl)propane, 2,2-bis(4-hydroxy-3,5-dibromophenyl)propane, and 2,2-bis(4-hydroxy-3,5-dichlorophenyl)propane; bis(hydroxyaryl)cycloalkanes such as 1,1-bis(4-hydroxyphenyl)cyclopentane, and 1,1-bis(4-hydroxyphenyl)cyclohexane; dihydroxydiaryl ethers such as 4,4′-dihydroxydiphenyl ether, and 4,4′-dihydroxy-3,3′-dimethyldiphenyl ether; dihydroxydiaryl sulfides such as 4,4′-dihydroxydiphenyl sulfide, and 4,4′-dihydroxy-3,3′-dimethyldiphenyl sulfide; dihydroxydiaryl sulfoxides such as 4,4′-dihydroxydiphenyl sulfoxide; and dihydroxydiaryl sulfones such as 4,4′-dihydroxydiphenyl sulfone, and 4,4′-dihydroxy-3,3′-dimethyldiphenyl sulfone besides bisphenol A. These can be used alone, or as a mixture of two or more.

Piperazine, dipiperidyl hydroquinone, resorcin, a 4,4′-dihydroxydiphenyl compound, or the like may be used together besides the above.

Additionally, the above dihydroxydiaryl compound and a trihydric or more phenolic compound as shown below may be mixed and used. Examples of the trihydric or more phenolic compound include phloroglucin, 4,6-dimethyl-2,4,6-tri-(4-hydroxyphenyl)-heptene-2; 4,6-dimethyl-2,4,6-tri-(4-hydroxyphenyl)-heptane; 1,3,5-tri-(4-hydroxyphenyl)-benzol; 1,1,1-tri-(4-hydroxyphenyl)-ethane; and 2,2-bis-(4,4′-(4,4′-hydroxydiphenyl)cyclohexyl)-propane.

When the polycarbonate resin is produced, the weight average molecular weights are usually 10000 to 80000 and are preferably 15000 to 60000. A molecular weight modifier, a catalyst, and the like can be used in the production if needed.

Examples of the styrene-based resin include rubber-reinforced styrene-based resins and non-rubber-reinforced styrene-based resins. These can be used alone, or in combination of two or more. The above rubber-reinforced styrene-based resin and non-rubber-reinforced styrene-based resin are obtained by polymerizing an aromatic vinyl monomer alone or both an aromatic vinyl monomer and another monomer that can be copolymerized with the aromatic vinyl monomer in the presence of and in the absence of a rubbery polymer, respectively.

Examples of the rubbery polymer include diene rubbers such as polybutadiene, polyisoprene, butadiene-styrene copolymers, isoprene-styrene copolymers, butadiene-acrylonitrile copolymers, butadiene-isoprene-styrene copolymers and polychloroprene; acrylic rubbers such as polybutyl acrylate; ethylene-α-olefin-nonconjugated diene copolymers; polyorganosiloxane rubbers; and also composite rubbers consisting of two or more rubbers of these. These can be used alone, or in combination of two or more.

Examples of the aromatic vinyl monomer include styrene, α-methylstyrene, para-methylstyrene, and bromostyrene. These can be used alone, or in combination of two or more. Styrene and α-methylstyrene are particularly preferable among these.

As the other monomer that can be copolymerized with the aromatic vinyl monomer, for example, vinyl cyanide monomers such as acrylonitrile, methacrylonitrile, ethacrylonitrile, fumaronitrile; (meth)acrylate ester monomers such as methyl (meth)acrylate, ethyl (meth)acrylate, propyl (meth)acrylate, butyl (meth)acrylate, 2-ethylhexyl acrylate, phenyl (meth)acrylate, 4-t-butylphenyl (meth)acrylate, bromophenyl (meth)acrylate, dibromophenyl (meth)acrylate, 2,4,6-tribromophenyl(meth)acrylate, monochlorophenyl (meth)acrylate, dichlorophenyl (meth)acrylate, and trichlorophenyl (meth)acrylate; and maleimide monomers such as N-phenyl maleimide, and N-cyclohexyl maleimide are used. These can be used alone, or in combination of two or more.

Specific examples of the rubber-reinforced styrene-based resin include a rubber-reinforced polystyrene resin (HIPS resin), an acrylonitrile-butadiene rubber-styrene copolymer (ABS resin), an acrylonitrile-acrylate ester rubber-styrene copolymer (AAS resin), an acrylonitrile-ethylene propylene diene rubber-styrene copolymer (AES resin), and a methyl methacrylate-butadiene-styrene copolymer (MBS resin).

When the rubber-reinforced styrene-based resin is used, the content of the rubbery polymer is not limited, but it is preferable that 5 to 70 mass % of the rubbery polymer be contained in 100 mass % of the rubber-reinforced styrene-based resin in view of the balance among physical properties such as shock resistance, fluidity and heat resistance of the resin composition obtained finally.

Examples of the non-rubber-reinforced styrene-based resin include a styrene polymer (PS resin), a styrene-acrylonitrile copolymer (AS resin), an α-methylstyrene-acrylonitrile copolymer (αMS-ACN resin), a methyl methacrylate-styrene copolymer (MS resin), a methyl methacrylate-acrylonitrile-styrene copolymer (MAS resin), a styrene-N-phenyl maleimide copolymer (St-NPMI resin), and a styrene-N-phenyl maleimide-acrylonitrile copolymer (St-AN-NPMI resin).

The method for producing a styrene-based resin used in the present embodiment is not particularly limited, and the styrene-based resin can be obtained by emulsion polymerization, suspension polymerization, bulk polymerization, solution polymerization, or a combination of these methods.

The thermoplastic resin composition of the present embodiment contains 0.01 to 3 parts by mass of the ultraviolet absorber with respect to 100 parts by mass of the thermoplastic resin. The thermoplastic resin composition tends to be inferior in light resistance for less than 0.01 parts by mass of the content, but inferior in moist heat resistance for more than 3 parts by mass. The content is more preferably 0.03 to 2 parts by mass, and still more preferably 0.05 to 1 part by mass.

Examples of the ultraviolet absorber include benzophenone compounds, benzotriazole compounds, triazine compounds, salicylate compounds, cyanoacrylate compounds, benzoic acid compounds, oxalic acid anilide compounds, and metal complex salts of nickel compounds. These can be used alone, or in combination of two or more. Benzotriazole ultraviolet absorbers are preferable in view of light resistance, including 2-(2H-benzotriazol-2-yl)-4-(1,1,3,3-tetramethylbutyl)phenol available as TINUVIN 329 produced by Ciba Japan K.K.

The thermoplastic resin composition of the present embodiment contains 0.01 to 3 parts by mass of the N—R type hindered amine for 100 parts by mass of the thermoplastic resin. The thermoplastic resin composition tends to be inferior in light resistance for less than 0.01 parts by mass of the content, but inferior in moist heat resistance for more than 3 parts by mass. The content is more preferably 0.03 to 2 parts by mass, and still more preferably 0.05 to 1 part by mass.

The N—R type hindered amine light stabilizer means such a hindered amine light stabilizer other than an N—H type hindered amine light stabilizer, in which the hydrogen atom bonded to the nitrogen atom of the piperidine skeleton is not replaced by a alkyl group (the hydrogen atom remains) and an N—CH₃ type hindered amine light stabilizer, in which the hydrogen atom bonded to the nitrogen atom of the piperidine skeleton is replaced by a methyl group. Examples of the N—R type hindered amine light stabilizer include ADK STAB LA-81 produced by ADEKA CORPORATION and Sanol LS2626 produced by Sankyo Kasei Co., Ltd., but a polycondensate of dimethyl succinate and 4-hydroxy-2,2,6,6-tetramethyl-1-piperidine ethanol is particularly preferable in view of light resistance, and is available as, for example, TINUVIN622 produced by BASF Japan Ltd.

It is preferable that the thermoplastic resin composition of the present embodiment further contain 0.01 to 1 part by mass of an N—CH₃ type hindered amine light stabilizer with respect to 100 parts by mass of the thermoplastic resin. Light resistance tends to be further improved in the case of 0.01 parts by mass or more, and a decrease in moist heat resistance tends to be able to be suppressed in the case of 1 part by mass or less. The content is preferably 0.03 to 0.6 parts by mass, and still more preferably 0.05 to 0.3 parts by mass.

The N—CH₃ type hindered amine light stabilizer is available as, for example, ADK STAB LA-52, ADK STAB LA-63P and ADK STAB LA-72 produced by ADEKA CORPORATION, and TINUVIN PA 144 and TINUVIN 765 produced by BASF Japan Ltd.

Additionally, antioxidants such as hindered phenols, sulfur-containing organic compounds and phosphorus-containing organic compounds; heat stabilizers such as phenols and acrylates; lubricants such as organic nickel compounds and higher fatty acid amides; plasticizers such as phosphate esters; halogen-containing compounds such as polybromophenyl ether, tetrabromobisphenol-A, a brominated epoxy oligomer and bromides; flame retardants or a flame retardant aids such as phosphorous-based compounds and antimony trioxide; odor masking agents; carbon black; titanium oxide; pigments; dyes; and the like can be added to the thermoplastic resin of the present embodiment if needed. Additionally, reinforcing agents or fillers such as talc, calcium carbonate, aluminium hydroxide, glass fibers, glass flakes, glass beads, carbon fibers, and metal fibers can be added.

The thermoplastic resin composition of the present embodiment can be obtained by mixing the above components. For example, a well-known kneading device such as an extruding machine, a roll, a Banbury mixer, or a kneader can be used for mixing. The mixing order is also not limited at all.

### EXAMPLES

The present invention will be described in detail based on Examples below, though the invention is not limited thereto. All the parts and % shown in Examples are by mass.

<Used Component>

### Polycarbonate Resin (A)

### A-1: Calibre 200-20 Produced by Sumitomo Dow Limited

Rubber-Reinforced Styrene-Based Resin (B)

Rubber-Reinforced Styrene-Based Resin (B-1): a pressure-resistant polymerization reactor was charged with 138 parts of water for polymerization, and 50 parts of polybutadiene latex (weight average particle size 0.39 μm) (solid content), purged with nitrogen, and when the temperature within the reactor reached 61° C. by heating, a solution obtained by dissolving 0.16 parts of potassium persulfate in 11 parts of deionized water was added. When the temperature reached 65° C., a mixed liquid of 13 parts of acrylonitrile, 37 parts of styrene, and 0.15 parts of t-dodecyl mercaptan, and an aqueous solution of emulsifier obtained by dissolving 1.5 parts of sodium dehydroabietate in 20 parts of deionized water were sequentially added over 4.5 hours. Subsequently, the polymerization was ended when the polymerization conversion rate exceeded 98%. Thereafter, salting-out, dewatering and drying were conducted to obtain a rubber-reinforced styrene-based resin (B-1).

Rubber-Reinforced Styrene-Based Resin (B-2): in a polymerization reactor provided with stirring blades, 0.3 parts of hydroxyethyl cellulose was dissolved as a suspension stabilizer in 300 parts of pure water, and then 50 parts of ethylene-propylene-ethylidene norbornene copolymer rubber (ethylene content of 55%, Mooney viscosity (ML1+4, 121° C.) 60) cut into 3-mm square was charged thereinto to make a suspension. Subsequently, 37 parts of styrene, 13 parts of acrylonitrile, 3.0 parts of t-butylperoxy pivalate as a polymerization initiator, and 0.1 parts of t-dodecyl mercaptan as a molecular weight modifier were added, and polymerization was conducted at 100° C. for 1 hour. After the polymerization, the mixture was dewatered to obtain a rubber-reinforced styrene-based resin (B-2).

Ultraviolet Absorber (C)

C-1: TINUVIN 329 produced by Ciba Japan K.K.

Hindered Amine Light Stabilizer (D)

D-1: N—R Type Hindered Amine Light Stabilizer TINUVIN622 produced by BASF Japan Ltd.
D-2: N—R Type Hindered Amine Light Stabilizer Sanol LS2626 produced by Sankyo Kasei Co., Ltd.
D-3: N—CH₃ Type Hindered Amine Light Stabilizer ADK STAB LA-63P produced by ADEKA CORPORATION
D-4: N—H Type Hindered Amine Light Stabilizer CHIMASSORB2020 produced by BASF Japan Ltd.

### Examples 1 to 7 and Comparative Examples 1 to 5

The above polycarbonate resin (A), rubber-reinforced styrene-based resin (B), ultraviolet absorber (C) and hindered amine light stabilizer (D) were mixed at proportions (unit: part by mass) shown in Table 1. Further, 3.6 parts of R-TC30 (titanium oxide produced by Huntsman International LLC.) was added. The mixture was melted and mixed at a cylinder temperature of 250 to 270° C. and pelletized by using a 50-mm extruding machine (manufactured by ON Machinery Co., Ltd.). The moist heat resistance was measured by using the obtained pellets. The following test specimens were produced with an injection molding machine by using the obtained pellets, and the light resistance was measured. Measurement results are shown in Table 1.

(Evaluation of Light Resistance)

The test specimens of 50 mm×100 mm×3 mm in thickness were irradiated with light at an exposure amount of 150 MJ/m² under the conditions of 83° C. and no rain by using a xenon weather meter for light resistance SX75 (manufactured by Suga Test Instruments Co., Ltd.). The colors were measured by JIS Z8729 as to the test specimens before and after exposure, and light resistance was measured by color difference (ΔE) and evaluated as follows.

### A: ΔE<2

### B: 2≤ΔE<5

### C: 5≤ΔE<10

### D: 10≤ΔE

(Evaluation of Moist Heat Resistance)

As to the above pellets produced by melting and mixing the above components, the melt flow rates were measured under the conditions of 220° C. and 10 kg (unit: g/10 min) according to ASTM D-1238, and these were defined as reference values. Thereafter, the melt flow rates of the above pellets after being exposed to high temperature and humidity environment under the conditions of 90° C. and RH 95% for 200 hours were measured under the conditions of 220° C. and 10 kg (unit: g/10 min) according to ASTM D-1238 similarly. The rates of change after exposure when the reference values were taken at 100% were measured, and they were evaluated as A for less than 300%, as B for 300% or more and 1000% or less, and as C for 1000% or more, or foam generation.

TABLE 1

| | | | | | | | | Compar- | Compar- | Compar- | Compar- | Compar- |
|---|---|---|---|---|---|---|---|---|---|---|---|---|
| | Exam- | Exam- | Exam- | Exam- | Exam- | Exam- | Exam- | ative | ative | ative | ative | ative |
| | ple 1 | ple 2 | ple 3 | ple 4 | ple 5 | ple 6 | ple 7 | Example 1 | Example 2 | Example 3 | Example 4 | Example 5 |
| Polycarbonate | | | | | | | | | | | | |
| resin (A) | | | | | | | | | | | | |
| A-1 | 70 | 60 | 50 | 60 | 60 | 40 | 50 | 60 | 60 | 60 | 60 | 60 |
| Rubber- | | | | | | | | | | | | |
| reinforced | | | | | | | | | | | | |
| styrene-based | | | | | | | | | | | | |
| resin (B) | | | | | | | | | | | | |
| B-1 | 30 | 40 | 50 | 40 | 40 | 60 | — | 40 | 40 | 40 | 40 | 40 |
| B-2 | — | — | — | — | — | — | 50 | — | — | — | — | — |
| Ultraviolet | | | | | | | | | | | | |
| absorber (C) | | | | | | | | | | | | |
| C-1 | 0.5 | 0.3 | 0.1 | 2 | 0.01 | 0.3 | 0.4 | 0.3 | 0.3 | 0.3 | — | — |
| Hindered | | | | | | | | | | | | |
| arnine light | | | | | | | | | | | | |
| stabilizer (D) | | | | | | | | | | | | |
| D-1 | 0.1 | 0.8 | 0.4 | 0.5 | 0.5 | — | 0.4 | — | — | — | 0.5 | — |
| D-2 | — | — | — | — | — | 0.5 | — | — | — | — | — | — |
| D-3 | — | — | — | — | — | — | 0.1 | 0.5 | — | — | — | — |
| D-4 | — | — | — | — | — | — | — | — | 0.5 | — | — | — |
| Light | B | B | B | B | B | C | A | B | B | D | D | D |
| resistance | | | | | | | | | | | | |
| Moist heat | A | B | A | B | A | B | B | C | C | A | A | A |
| resistance | | | | | | | | | | | | |

### INDUSTRIAL APPLICABILITY

The thermoplastic resin composition of the present invention is excellent in light resistance and moist heat resistance and can be preferably used particularly as car interior parts besides building materials, household appliances, OA equipment and the like.

1. A thermoplastic resin composition, comprising:
a thermoplastic resin consisting of 30 to 90 mass % of a polycarbonate resin and 10 to 70 mass % of a styrene-based resin;
an ultraviolet absorber; and
an N—R type hindered amine light stabilizer,
wherein the content of the ultraviolet absorber is 0.01 to 3 parts by mass, and the content of the N—R type hindered amine light stabilizer is 0.01 to 3 parts by mass with respect to 100 parts by mass of the thermoplastic resin.

2. The thermoplastic resin composition according to claim 1, wherein the N—R type hindered amine light stabilizer is a polycondensate of dimethyl succinate and 4-hydroxy-2,2,6,6-tetramethyl-1-piperidine ethanol.

3. The thermoplastic resin composition according to claim 1, further comprising:
an N—CH₃ type hindered amine light stabilizer,
wherein the content of the N—CH₃ type hindered amine light stabilizer is 0.01 to 1 part by mass with respect to 100 parts by mass of the thermoplastic resin.

4. The thermoplastic resin composition according to claim 2, further comprising:
an N—CH₃ type hindered amine light stabilizer,
wherein the content of the N—CH₃ type hindered amine light stabilizer is 0.01 to 1 part by mass with respect to 100 parts by mass of the thermoplastic resin.
